(19) United States
(12) Patent Application Publication
(10) Pub. No.: US 2014/0085340 A1
(43) Pub. Date: Mar. 27, 2014

(54) METHOD AND ELECTRONIC DEVICE FOR MANIPULATING SCALE OR ROTATION OF GRAPHIC ON DISPLAY

(71) Applicant: ESTsoft Corp., Seoul (KR)

(72) Inventor: Jang-Joong KIM, Seoul (KR)

(73) Assignee: ESTsoft Corp., Seoul (KR)

(21) Appl. No.: 14/034,499

(22) Filed: Sep. 23, 2013

(30) Foreign Application Priority Data
Sep. 24, 2012 (KR) 10-2012-0105935

(51) Int. Cl. G06F 3/0484; G06T 3/40; G06T 3/60

(52) U.S. Cl. CPC G06F 3/04845; G06T 3/60; G06T 3/40
USPC 345/650; 345/661

(57) ABSTRACT

Provided are a method and electronic device for simply manipulating a scale or rotation of a graphic on a display. The method is performed by any electronic device that includes a display, a processor, a memory and a program, or by any storage medium that can be read by a computer storing commands executable in an electronic device. This program may display a graphic on the display when executed by the processor. A user can simply scale up/down or rotate a graphic through a two-step manipulation of a touch and a touch-and-drag.

### TECHNICAL FIELD

The present invention relates to a technique to manipulate a graphic on a display of an electronic device and, more particularly, to a technique to manipulate a scale or rotation of a graphic on a touch-sensitive display in a mobile electronic device.

### BACKGROUND

According as mobile electronic devices become more and more compact and the number of functions performed in such devices increases, it is highly important to properly design a user interface that allows a user to easily interact with such a multifunctional device. Particularly, this issue is more critical in mobile electronic devices having a smaller display rather than in desktop or laptop computers.

A user interface is a kind of gateway that permits a user to view, find, select, access, or utilize contents, features, functions, and data of electronic devices. Some mobile devices, especially referred to as mobile phones, cellular phones, smart phones, etc., tend to add much more push buttons to a user interface. Unfortunately, this causes an increase in density of push buttons, overload of functions of push buttons, and a complex menu system, thus leading a user to often undergo many discomforts in accessing, saving and manipulating data. Particularly, in case a user desires to scale or rotate a displayed graphic, user interfaces of conventional electronic devices require a user to take complicated actions or memorize multi-layered hierarchical menu structure.

### SUMMARY

Accordingly, to address the above-mentioned problems and/or disadvantages and to offer at least the advantages described below, the present invention provides a method and electronic device for simply manipulating a scale or rotation of a graphic on a display.

According to one aspect of the present invention, provided is a method for manipulating a graphic on a display of an electronic device which includes the display, at least one processor, a memory, and at least one program stored in the memory and executed by the processor, the graphic being displayed on the display when the program is executed. The method may comprise a first step of recognizing a first control point in response to a first user's input corresponding to a first location on the graphic displayed on the display; a second step of recognizing a second control point in response to a second user's input corresponding to a second location on the graphic after the first user's input for the first control point is released; and a third step of scaling or rotating the graphic by determining that a relative location of the second control point with regard to the first location corresponding to the first control point is moved from the second location to a third location on the graphic when the second user's input is moved to the third location.

In the method, the third step may include, if the second user's input is moved before a predetermined time, maintaining a current mode which is one of a scaling mode and a rotating mode; and if the second user's input is moved after the predetermined time, changing the current mode to another mode which is the other of the scaling mode and the rotating.

In the method, the third step may include, in case of scaling the graphic, comparing a first virtual square region having a diagonal line of the shortest distance between the first location and the second location with a second virtual square region having a diagonal line of the shortest distance between the first location and the third location; and scaling up or down the graphic according to a variation rate of height and a variation rate of width between the first square region and the second square region.

In the method, the third step may include, in case of scaling the graphic, comparing a first virtual square region having a diagonal line of the shortest distance between the first location and the second location with a second virtual square region having a diagonal line of the shortest distance between the first location and the third location; and scaling up or down the graphic, based on one of a variation rate of height and a variation rate of width between the first square region and the second square region, while maintaining the ratio of height to width in the graphic.

In the method, the third step may include, in case of rotating the graphic, comparing a first virtual line formed of the shortest distance between the first location and the second location with a second virtual line formed of the shortest distance between the first location and the third location; and rotating the graphic according to an angle between the first line and the second line.

According to another aspect of the present invention, provided is an electronic device that comprises a display which displays a graphic; at least one processor; and a memory which stores at least one program executed by the processor, the graphic being displayed on the display when the program is executed. In the electronic device, the processor may be configured to recognize a first control point in response to a first user's input corresponding to a first location on the graphic; to recognize a second control point in response to a second user's input corresponding to a second location on the graphic after the first user's input for the first control point is released; and to scale or rotate the graphic by determining that a relative location of the second control point with regard to the first location corresponding to the first control point is moved from the second location to a third location on the graphic when the second user's input is moved to the third location.

In the electronic device, the processor may be further configured, if the second user's input is moved before a predetermined time, to maintain a current mode which is one of a scaling mode and a rotating mode; and if the second user's input is moved after the predetermined time, to change the current mode to another mode which is the other of the scaling mode and the rotating.

In the electronic device, the processor may be further configured, in case of scaling the graphic, to compare a first virtual square region having a diagonal line of the shortest distance between the first location and the second location with a second virtual square region having a diagonal line of the shortest distance between the first location and the third location; and to scale up or down the graphic according to a variation rate of height and a variation rate of width between the first square region and the second square region.

In the electronic device, the processor may be further configured, in case of scaling the graphic, to compare a first virtual square region having a diagonal line of the shortest distance between the first location and the second location with a second virtual square region having a diagonal line of the shortest distance between the first location and the third location; and to scale up or down the graphic, based on one of a variation rate of height and a variation rate of width between the first square region and the second square region, while maintaining the ratio of height to width in the graphic.

In the electronic device, the processor may be further configured, in case of rotating the graphic, to compare a first virtual line formed of the shortest distance between the first location and the second location with a second virtual line formed of the shortest distance between the first location and the third location; and to rotate the graphic according to an angle between the first line and the second line.

According to still another aspect of the present invention, provided is a computer-readable storage medium storing therein a program executing steps of recognizing a first control point in response to a first user's input corresponding to a first location on a graphic displayed on a display of an electronic device; recognizing a second control point in response to a second user's input corresponding to a second location on the graphic after the first user's input for the first control point is released; and scaling or rotating the graphic by determining that a relative location of the second control point with regard to the first location corresponding to the first control point is moved from the second location to a third location on the graphic when the second user's input is moved to the third location.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is a block diagram illustrating an electronic device in accordance with an embodiment of the present invention.

FIG. 2 is a flow diagram illustrating a method for manipulating a graphic in accordance with an embodiment of the present invention.

FIG. 3 shows a user interface for scaling a graphic in a graphic manipulation method in accordance with an embodiment of the present invention.

FIG. 4 shows a scheme of scaling a graphic in a graphic manipulation method in accordance with an embodiment of the present invention.

FIG. 5 shows a user interface for rotating a graphic in a graphic manipulation method in accordance with an embodiment of the present invention.

### DETAILED DESCRIPTION

The following description with reference to the accompanying drawings is provided to assist in a comprehensive understanding of various embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present invention is provided for illustration purpose only and not for the purpose of limiting the present invention as defined by the appended claims and their equivalents.

It is to be understood that the singular forms “a,” “an,” and “the” include plural referents unless the context clearly dictates otherwise. Thus, for example, reference to “an input unit” includes reference to one or more of such input units.

This invention may be applied to a great variety of electronic devices, such as computers (including any kind of portable computers), personal digital assistants (PDAs), mobile phones, and smart phones, which includes a display (having a user interface), a processor, a memory, and a set of programs or commands to be executed by the processor. For simplification, an embodiment disclosed hereinafter will be focused on a mobile multi-functional device such as a smart phone having a touch-sensitive display and associated processor. This is, however, exemplary only and not to be considered as a limitation of the present invention. Alternatively, any other electronic device such as a personal computer or a laptop computer that can include a normal display instead of a touch-sensitive display and at least one physical user interface unit such as a physical click wheel, a physical keyboard, a mouse and/or a joystick.

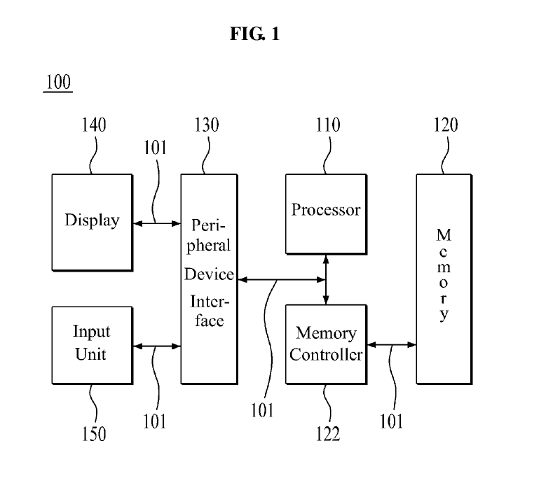

Now, an electronic device will be described with reference to FIG. 1. FIG. 1 is a block diagram illustrating an electronic device 100 having a touch-sensitive display 140 in accordance with an embodiment of the present invention.

Referring to FIG. 1, the electronic device 100 includes at least one processor 110, a memory 120 having at least one computer-readable storage medium, a memory controller 122, a peripheral device interface 130, the touch-sensitive display 140, and an input unit 150. The electronic device 100 may further include a power supply unit, a communication module, a radio frequency (RF) circuit, an audio processing circuit, a speaker, a microphone, various sensors, or the like. Additionally, the electronic device 100 may be configured such that the above elements can communicate with each other through at least one bus or signal line 101. The above-discussed device 100 may essentially or optionally include any other elements, not shown in FIG. 1, and some of the above-mentioned elements in the device 100 may be omitted or replaced with another.

The memory 120 may include a high-speed random access memory (RAM) and also include at least one of a magnetic disk, a flash memory, and any other nonvolatile memory. The memory controller 122 may control access to the memory 120 by any other element such as the processor 110 and the peripheral device interface 130.

The peripheral device interface 130 connects any peripheral device for input and output of the electronic device 100 to the processor 110 and the memory 120. The processor 110 performs various functions of the electronic device 100 and also processes associated data by executing a set of software programs and/or commands stored in the memory 120. Instead of the touch-sensitive display 140 which will be fully described below, any other type display having no touch-sensitive function may be used as a peripheral device for input and output of the electronic device 100. Used as another peripheral device is the input unit 150 that receives a user's input action and thereby creates a corresponding input signal. The input unit 150 may include a physical button, a dial, a slider switch, a joystick, a click wheel, a keyboard, a mouse, a touch pad (having a touch-sensitive surface without offering a visual display unlike the touch-sensitive display 140), and the like.

The touch-sensitive display 140 provides both an input interface and an output interface between the electronic device 100 and a user. For example, the touch-sensitive display 140 may create an electrical signal by detecting a user's touch input or display a visual output to a user by receiving instructions from the processor 110. Here, a visual output may include an image, an electronic document, a text, an icon, a video, and any combination thereof (herein, collectively referred to as ‘graphic’). Further, the touch-sensitive display 140 may have a touch-sensitive surface that can receive a user's touch input based on a haptic contact and/or a tactile contact. Specifically, the touch-sensitive display 140 detects a user's contact (or a move or release of such a contact) on the touch-sensitive surface and then converts a detected touch state into an electrical signal by means of interaction with a user interface. Meanwhile, a user's contact may be made using a user's finger or any other touch tool such as a stylus pen on the touch-sensitive display 140.

The touch-sensitive display 140 may be formed of LCD (Liquid Crystal Display), LDP (Light Emitting Polymer Display), or any other equivalent display unit. Meanwhile, capacitive technology, resistive technology, infrared technology, surface acoustic wave technology, proximity sensor array technology, or any other suitable technology may used as touch-sensing technology for the touch-sensitive display 140. Using such touch-sensing technology, the touch-sensitive display 140 may detect a user's contact (such as a touch, a long press, a multi touch, etc.), a move of contact (such as a drag, a panning, a swipe, a flick, a scroll, etc.), and a release of contact.

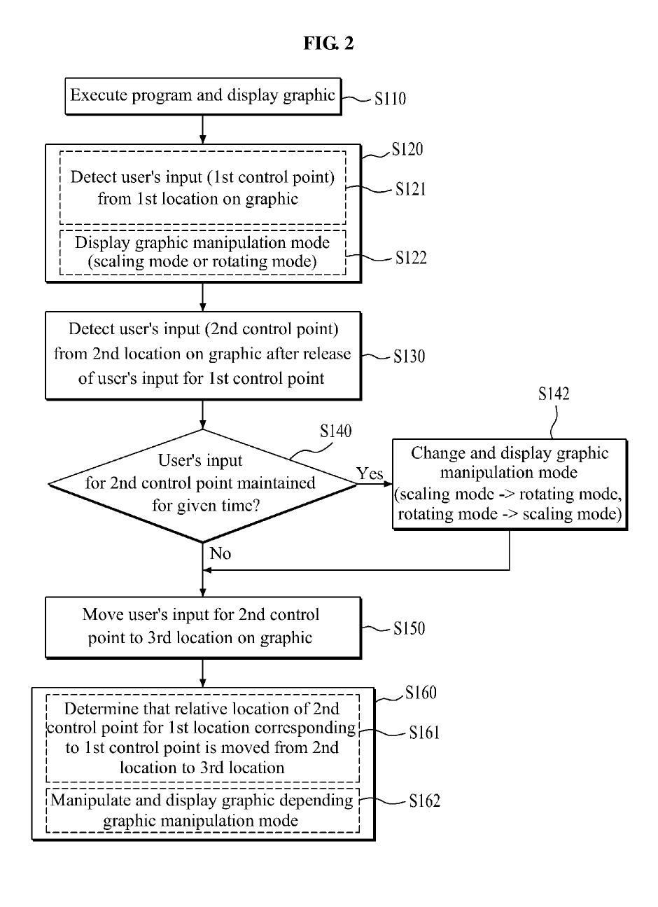

Now, a graphic manipulation method in accordance with embodiments of the present invention will be described in detail with reference to FIGS. 2 to 5. In one embodiment, a user's input is made when his or her finger (or any touch tool) is in contact with a graphic displayed on the touch-sensitive display. Namely, a user's input starts in response to a contact of a user's finger on a touch-sensitive region of the display, and then ends in response to a release of contact. A user's input using the touch-sensitive display may be performed in the form of a touch, a long press, a drag (i.e., a move of contact without release), a release of a contact state, and the like. Meanwhile, the graphic manipulation method of this invention may be alternatively applied to an electronic device having any type display other than the touch-sensitive display. In this case, a user's input may be performed using other suitable input unit or mechanism such as a mouse. If a mouse is used for example, a user's input may be performed by placing a mouse pointer at any location on a graphic and then clicking a button of a mouse (corresponding to ‘a touch’), by maintaining a click state (corresponding to ‘a long press’), by moving a mouse pointer in a click state (corresponding to ‘a drag’), or by releasing a click state (corresponding to ‘a release of a contact state’).

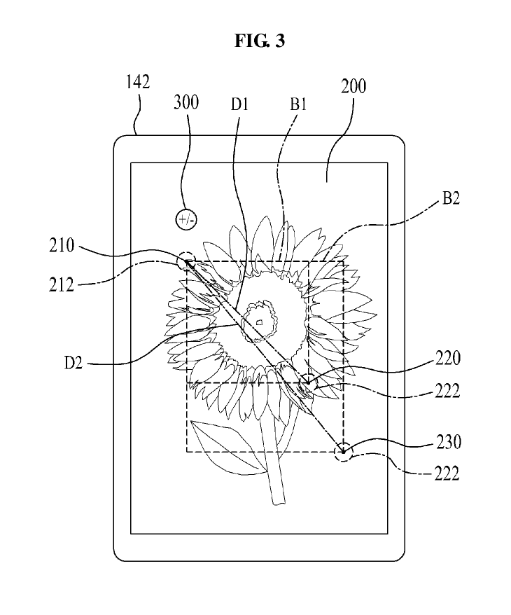

Referring to FIGS. 2 and 3, at step S110, the processor 110 executes a program stored in the memory 120 and displays at least one graphic 200 on a display region 142 of the display 140 in response to a user's input. Thereafter, a user touches a certain location on the graphic 200 with his or her finger (or using any touch tool). Then, at step S120, the processor 110 recognizes, as the first control point, coordinates of a user's input (namely, the first location of a user's touch) on the display region 142 of the display 140. Specifically, when a user's input 212 is detected from the first location 210 on the graphic 200, the processor 110 recognizes the first control point by identifying coordinates of the first location 210 at step S121. At this time, the processor 110 may notify a current graphic manipulation mode to a user through the display 140 at step S122. For example, the display 140 may display thereon an icon 300 that indicates one of a scaling mode and a rotating mode. This icon 300 exemplarily shown in FIG. 3 indicates that a current graphic manipulation mode is a scaling mode.

Thereafter, a user releases the user's input 212 corresponding to the first control point and then touches another location 220 (namely, the second location) on the graphic 200. Then, at step S130, the processor 110 detects a corresponding user's input 222 and recognizes the second control point by identifying coordinates of the second location 220 on the display region 142.

After the second control point is recognized, the processor 110 manipulates the graphic 200 on the basis of a user's input type of the second control point 220. Specifically, the processor 110 determines at step S140 whether a user's input type is “a drag” or “a long press and drag”, and depending on the result of determination, maintains or changes a current graphic manipulation mode. For example, if the second user's input 222 is a drag before a predetermined time (i.e., in case of “a drag”), a current graphic manipulation mode (i.e., a specific mode indicated by the icon 300 at step S122) is maintained. In contrast, if the second user's input 222 is a drag after a predetermined time (i.e., in case of “a long press and drag”), a current mode (e.g., a scaling mode) is changed to another mode (e.g., a rotating mode) at step S142. In this case, the icon 300 is also changed to indicate a changed graphic manipulation mode.

Meanwhile, if the second user's input 222 at the second location 220 is moved to the third location 230 on the graphic 200 through a drag input at step S150, the processor 110 determines at step S161 that a relative location of the second control point with regard to the first location 210 corresponding to the first control point is moved from the second location 220 to the third location 230. Further, the processor 110 controls the display 140 to display a new graphic which is manipulated by scaling or rotating the graphic 200 at step S162.

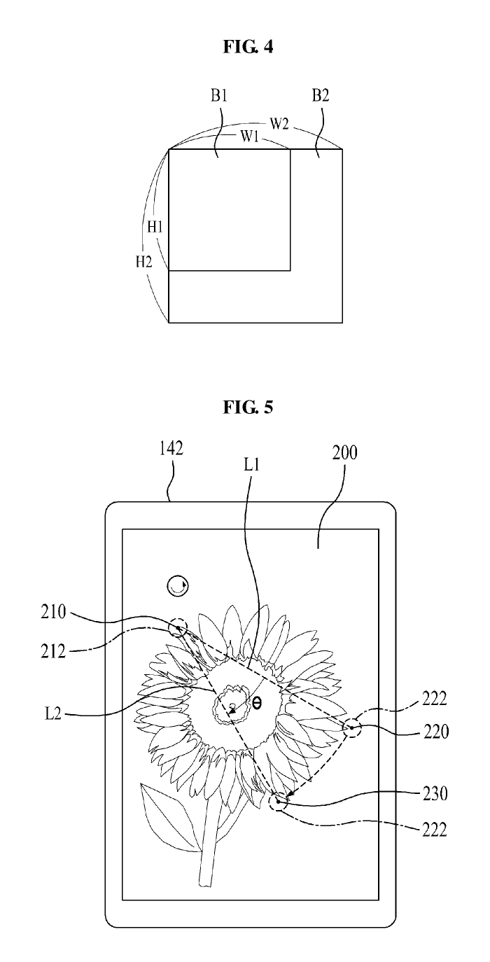

There are two types of scaling a graphic. The first type is to compare the first virtual square region B1 having a diagonal line of the shortest distance D1 between the first location 210 and the second location 220 with the second virtual square region B2 having a diagonal line of the shortest distance D2 between the first location 210 and the third location 230, and then to scale up or down the original graphic 200 according to a variation rate of height and a variation rate of width between the first square region B1 and the second square region B2. For example, as shown in FIG. 4, if the height and width of the first square region B1 are denoted by H1 and W1 and similarly if the height and width of the second square region B2 are denoted by H2 and W2, the height (H) and width (W) of the original graphic 200 are changed as follows.

H*=H×(H2/H1) [Height of graphic to be displayed]

W*=W×(W2/W1) [Width of graphic to be displayed]

The second type of scaling a graphic is to scale up or down the graphic while maintaining the ratio of height to width in the original graphic 200. Namely, based on one of a variation rate of height and a variation rate of width between the first square region B1 and the second square region B2, the graphic is scaled up or down. For example, function F is defined as the maximum or minimum value between two input variables, and the height (H) and width (W) of the original graphic 200 are changed as follows.

H*=H×F(H2/H1, W2/W1) [Height of graphic to be displayed]

W*=W×F(H2/H1, W2/W1) [Width of graphic to be displayed]

In the above-discussed first scaling type, the height and width of the original graphic 200 may be changed in different rates. Therefore, the first scaling type may cause the distortion of graphic. In contrast, in case of the second scaling type, the height and width of the original graphic 200 are changed in the same rate. For example, if a value of H2/H1 is greater than a value of W2/W1 and if function F is defined as the maximum value, the value of function F becomes H2/H1 regardless of height and width. Therefore, since changes in height and width depend on the same rate, the second scaling type may not cause the distortion of graphic.

Meanwhile, in case of rotating the graphic 200 (i.e., in case of a rotating mode), as shown in FIG. 5, the processor 110 compares the first virtual line L1 formed of the shortest distance between the first location 210 and the second location 220 with the second virtual line L2 formed of the shortest distance between the first location 210 and the third location 230, and then rotates the original graphic 200 according to an angle θ between the first line L1 and the second line L2. This rotation of the graphic 200 is performed on the first location 210.

This invention may be provided as any electronic device that includes a display, a processor, a memory and a program, or as any storage medium that can be read by a computer storing commands executable in an electronic device. This program may display a graphic on the display when executed by the processor. A user can simply scale up/down or rotate a graphic through a two-step manipulation of a touch and a touch-and-drag.

Particularly, this invention may be favorably applied to an electronic device having a touch-sensitive display. A user can scale or rotate a graphic through twice touch-based manipulations only. Such a graphic manipulation method may be very helpful to a one-hand manipulation in mobile electronic devices, and may also provide an intuitive and convenient user interface to a user.

While this invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. A method for manipulating a graphic on a display of an electronic device which includes the display, at least one processor, a memory, and at least one program stored in the memory and executed by the processor, the graphic being displayed on the display when the program is executed, the method comprising:
a first step of recognizing a first control point in response to a first user's input corresponding to a first location on the graphic displayed on the display;
a second step of recognizing a second control point in response to a second user's input corresponding to a second location on the graphic after the first user's input for the first control point is released; and
a third step of scaling or rotating the graphic by determining that a relative location of the second control point with regard to the first location corresponding to the first control point is moved from the second location to a third location on the graphic when the second user's input is moved to the third location.

2. The method of claim 1, wherein the third step includes:
if the second user's input is moved before a predetermined time, maintaining a current mode which is one of a scaling mode and a rotating mode; and
if the second user's input is moved after the predetermined time, changing the current mode to another mode which is the other of the scaling mode and the rotating.

3. The method of claim 1, wherein the third step includes:
in case of scaling the graphic,
comparing a first virtual square region having a diagonal line of the shortest distance between the first location and the second location with a second virtual square region having a diagonal line of the shortest distance between the first location and the third location; and
scaling up or down the graphic according to a variation rate of height and a variation rate of width between the first square region and the second square region.

4. The method of claim 1, wherein the third step includes:
in case of scaling the graphic,
comparing a first virtual square region having a diagonal line of the shortest distance between the first location and the second location with a second virtual square region having a diagonal line of the shortest distance between the first location and the third location; and
scaling up or down the graphic, based on one of a variation rate of height and a variation rate of width between the first square region and the second square region, while maintaining the ratio of height to width in the graphic.

5. The method of claim 1, wherein the third step includes:
in case of rotating the graphic,
comparing a first virtual line formed of the shortest distance between the first location and the second location with a second virtual line formed of the shortest distance between the first location and the third location; and
rotating the graphic according to an angle between the first line and the second line.

6. An electronic device comprising:
a display which displays a graphic;
at least one processor; and
a memory which stores at least one program executed by the processor, the graphic being displayed on the display when the program is executed,
wherein the processor is configured:
to recognize a first control point in response to a first user's input corresponding to a first location on the graphic;
to recognize a second control point in response to a second user's input corresponding to a second location on the graphic after the first user's input for the first control point is released; and
to scale or rotate the graphic by determining that a relative location of the second control point with regard to the first location corresponding to the first control point is moved from the second location to a third location on the graphic when the second user's input is moved to the third location.

7. The electronic device of claim 6, wherein the processor is further configured:
if the second user's input is moved before a predetermined time, to maintain a current mode which is one of a scaling mode and a rotating mode; and
if the second user's input is moved after the predetermined time, to change the current mode to another mode which is the other of the scaling mode and the rotating.

8. The electronic device of claim 6, wherein the processor is further configured:
in case of scaling the graphic,
to compare a first virtual square region having a diagonal line of the shortest distance between the first location and the second location with a second virtual square region having a diagonal line of the shortest distance between the first location and the third location; and
to scale up or down the graphic according to a variation rate of height and a variation rate of width between the first square region and the second square region.

9. The electronic device of claim 6, wherein the processor is further configured:
in case of scaling the graphic,
to compare a first virtual square region having a diagonal line of the shortest distance between the first location and the second location with a second virtual square region having a diagonal line of the shortest distance between the first location and the third location; and
to scale up or down the graphic, based on one of a variation rate of height and a variation rate of width between the first square region and the second square region, while maintaining the ratio of height to width in the graphic.

10. The electronic device of claim 6, wherein the processor is further configured:
in case of rotating the graphic,
to compare a first virtual line formed of the shortest distance between the first location and the second location with a second virtual line formed of the shortest distance between the first location and the third location; and
to rotate the graphic according to an angle between the first line and the second line.

11. A computer-readable storage medium storing therein a program executing steps of:
recognizing a first control point in response to a first user's input corresponding to a first location on a graphic displayed on a display of an electronic device;
recognizing a second control point in response to a second user's input corresponding to a second location on the graphic after the first user's input for the first control point is released; and
scaling or rotating the graphic by determining that a relative location of the second control point with regard to the first location corresponding to the first control point is moved from the second location to a third location on the graphic when the second user's input is moved to the third location.
